(19) United States
(12) Patent Application Publication
(10) Pub. No.: US 2007/0180375 A1
(43) Pub. Date: Aug. 2, 2007

(54) Template format for calendars

(75) Inventors: Arye Gittelman, Mercer Island, WA (US); Florian W.H. Voss, Seattle, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: Microsoft Corporation, Redmond, WA (US)

(21) Appl. No.: 11/344,501

(22) Filed: Jan. 31, 2006

(51) Int. Cl. G06F 9/00

(52) U.S. Cl. 715/700; 715/764; 715/963

(57) ABSTRACT

Displaying a calendar. The method may be practiced, for example, in a computing environment. The method includes creating a calendar layout template as one or more data structures on a computer readable medium. The calendar layout template is independent of specific dates and schedule instances. A schedule of time and/or date specific events is created as one or more data structures on a computer readable medium. The schedule is alterable by user interaction. The calendar layout template is merged with the schedule of time and/or date specific events to create a calendar view in a dynamic fashion such that when the schedule is altered, altered information is merged with the calendar layout template.

### BACKGROUND

### Background and Relevant Art

Computers and computing systems have affected nearly every aspect of modern living. Computers are generally involved in work, recreation, healthcare, transportation, entertainment, household management, etc.

Computers may further include functionality for allowing design tools to be implemented on the computers. For example, a computer can run a software application that allows the user to design various graphic arts projects. In one example, software applications may be able to be used to design calendars. Using the software applications, a user can design the type of calendar such as a daily calendar, a weekly calendar, a monthly calendar, or a yearly calendar. Additionally, the user may add graphical features such as various images and the like. However, adding specific appointments to these calendars can be time consuming. If a new calendar is created, the specific appointments must be re-imported or re-entered into the calendar.

Computers additionally include functionality for allowing scheduling activities to be performed. For example, a user can input scheduling activities into a scheduling program. While these schedules can be printed, the range of calendar styles and formats is quite limited.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment described herein includes a method of displaying a calendar. The method may be practiced, for example, in a computing environment. The method includes creating a calendar layout template as one or more data structures on a computer readable medium. The calendar layout template is independent of specific dates and schedule instances. A schedule of time and/or date specific events is created as one or more data structures on a computer readable medium. The schedule is alterable by user interaction. The calendar layout template is merged with the schedule of time and/or date specific events to create a calendar view in a dynamic fashion such that when the schedule is altered, altered information is merged with the calendar layout template.

Another embodiment described herein includes one or more computer readable media. The one or more computer readable media include a first data structure. The first data structure includes information defining a calendar layout. The calendar layout is independent of specific dates and schedule instances. The one or more computer readable media further include a second data structure. The second data structure includes information defining a schedule of time and/or date specific events. The schedule is alterable by user interaction. The one or more computer readable media further include computer executable instructions configured to merge the information defining the first data structure with the information defining the schedule of time and/or date specific events in a dynamic fashion such that when the schedule is altered, altered information is merged with the one or more calendar layouts.

Yet another embodiment described herein includes a method of presenting calendar views including schedule information merged with a calendar layout template. The method may be practiced, for example, in a computer system having a graphical user interface including a display and a user interface selection device. The method includes displaying a selection of views representing selectable calendar layout templates. User input is received selecting one of the selectable calendar layout templates. A calendar view is displayed defined by schedule information including time and/or date information for specific events merged with the one of the selectable calendar layout templates selected by the received user input.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates various information that may be merged to create a calendar view;

FIG. 2 illustrates various time units that may be displayed in a calendar view;

FIG. 3 illustrates a list view and a slot view;

FIG. 4 illustrates a graphical user interface that may be used to select calendar layout templates;

FIG. 5 illustrates a method of displaying a calendar; and

FIG. 6 illustrates a method of presenting calendar views.

### DETAILED DESCRIPTION

Embodiments herein may comprise a special purpose or general-purpose computer including various computer hardware, as discussed in greater detail below.

One embodiment described in more detail below illustrates methods and data structures that may be used to create calendar views. Calendar views may be used to display schedule information in a particular format. For example, a user may select a layout format in which schedule information is to be displayed. Illustratively, the user may select schedule information to be displayed in a day format, a week format, a month format, a year format, or a multiyear format. Additionally, some calendar views may allow for schedule information to be displayed using a combination of formats. For example, one particular calendar view allows for both a day view and a week view to be displayed together.

A markup data structure may be used to define a particular view in which schedule information is displayed. The markup data structure may be, in one embodiment, a template layout that may be used to specify and/or define various features such as fonts, size, borders, column and row numbers, orientations, fills, and so forth. Because a markup data structure is used, the eventual calendar views in which schedule information is displayed may be very flexible and customizable. The markup data structure may include various variables and or links that allow the markup data structure to be merged with schedule information, style information, and various other external information to create the calendar views.

The markup data structure may be merged with the schedule information in a dynamic fashion. This allows for calendar views to be changed without the need to manually re-insert schedule information.

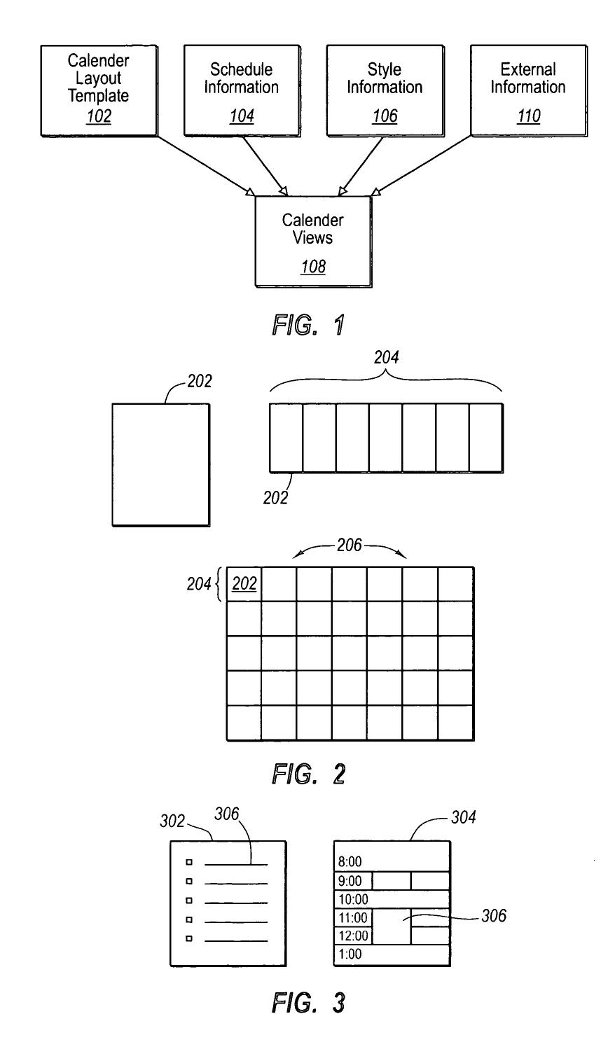

Referring now to FIG. 1, a diagrammatic example is illustrated. FIG. 1 illustrates a representation of a calendar layout template 102. The calendar layout template 102 may represent one or more time units. For example, the calendar layout template 102 may represent a day time unit, a week time unit, a month time unit, a year time unit, and/or a multi year time unit. The calendar layout template 102 may be formatted such that it includes combinations of time units as well. For example, the calendar layout template 102 may include a combination of a day time unit and a week time unit. In one particular embodiment, a primary time unit may include calendar controls for nested time units. For example a month time unit may include calendar controls for week time units and day time units that are part of the month time unit. The calendar layout template 102 may be, in one exemplary embodiment, embodied as a mark-up document, such as an XML document.

Referring once again to FIG. 1, FIG. 1 illustrates schedule information 104. The schedule information 104 may include specific scheduling instances and dates. For example, the schedule information may include a data structure that lists dates and/or times and activities or events corresponding with those dates and/or times. Often, the schedule information may be particular to an individual user. For example, the schedule information may define John's scheduled activities, including date and time, for the current year.

FIG. 1 further illustrates style information 106. The style information 106 may include a data structure that defines various style features. For example, the data structure may include information defining and/or specifying color schemes, fonts, border shading, button shading, and the like.

FIG. 1 illustrates that the calendar layout template 102, the schedule information 104, and the style information 106 can be merged to create a calendar view 108. As such, the calendar view 108 displays schedule information in a format as defined by the calendar layout template 102 and the style information 106.

Returning once again to the description of the calendar layout template 102, various features will be described. The calendar layout template 102 may include both fixed hard coded definitions as well as dynamic linking. Illustratively, the calendar layout template 102 may include dynamic linking information that specifies where the style information 106 is applied. Alternatively, the calendar layout template 102 may include fixed hard coded definitions of style information such that all or part of the style information 106 does not need to be merged with the calendar layout template 102 to achieve various style formats in the calendar view 108. Further, dynamic linking information may be included in the calendar layout template 102 to function as a pointer to the schedule information 104.

With respect to schedule information, while FIG. 1 illustrates that a single instance of schedule information 104 is included, it should be noted that multiple sources of schedule information may be applied to the calendar view 108. Additionally, the combination of multiple instances of schedule information can be used in a flexible manner to customize the calendar view 108. For example, in one embodiment, the calendar view 108 may display combined schedule information from a number of sources into a calendar view 108 which includes a single day time unit, week time unit, month time unit, year time unit, and/or multi year time unit. In an alternative embodiment, the calendar view 108 may display a side by side or top and bottom view where the schedule information 104 from each of the sources is displayed in each it's own day time unit, week time unit, month time unit, year time unit, and/or multi year time unit. In one embodiment, this allows different individuals schedules to be displayed and printed together. In one embodiment, a mark-up language used may specifically define side by side or top and bottom view tags to facilitate the display. Side by side, or top and bottom view calendars may be dynamic in one embodiment. For example, as a user adds additional schedule sources, template markup may create a new section for each schedule source. Thus, in this embodiment, the markup does not specify a particular number of calendars, but rather allows the calendar view 108 to show as many calendars with schedules as are actually added up to a predefined maximum.

Notably, the schedule information 104 may in one embodiment be supplied by a scheduling program such as Microsoft Outlook or other scheduling program. The calendar layout template 102 may be appropriately linked to the schedule information 104 such that the calendar layout template 102 can be modified or a new calendar layout template may be used where the schedule information 104 is linked such that it does not need to be imported into the calendar layout template 102 itself. This allows for changing the calendar layout template 102 or replacing the counter layout template 102 with a different calendar layout template without the need to re-import data from the schedule information 104.

The calendar layout template 102 may further include dynamic linking information to other content. For example, it may be desirable to create a calendar view 108 that includes images, motivational or entertaining text, maps, driving directions, or any one of a multitude of various external features. The calendar layout template 102 may include dynamic linking information to a data source for the external features. For example, a data source may provide an image and motivational text that changes each day. The calendar layout template 102 may include one or more links, such as a URI, URL, file location, or the like, that references one or more locations where the image and motivational text can be obtained. As such, the calendar view 108 may further present external information 110 as part of the calendar view 108.

Additionally, the calendar layout template may include functionality for including specific date information. For example, assume that a user wishes to print the day calendar view for one or more specific dates. The calendar layout template 102 may include a dynamic pointer that references one or more dates selected by a user using a date picker user interface widget. Computer executable instructions may then be implemented that cause the calendar view 108 to display a specific instance of the selected date(s) including appropriate schedule information 104 applicable to the current date(s).

As described previously, the calendar layout template 102 may define one or more time units such as day time units, week time units, month time units, year time units, multi year time units, and the like. Additionally, the calendar layout template 102 may define one or more time units within the same calendar layout template 102. For example, when a calendar layout template 102 defines a month time unit, there may also be a desire to define the day time units within the month time unit. In one embodiment, a primary time unit may include calendar controls for internal or nested time units. For example, a month time unit may include calendar controls for internal week time units and day time units. Additionally, there may be a desire to display time units in a disjointed fashion. For example, a calendar view 108 may include a large day time unit view and smaller disjointed week time unit, month time unit, and/or year time unit views.

The calendar layout template 102 may further include conditional formatting attributes. Using conditional format attributes, other attributes of the calendar view 108 may be formatted. Virtually any attribute can be conditionally formatted. In one specific example, the day number of a day in may be colored in red if the day is a Saturday or Sunday.

Another attribute that may be formatted in the calendar layout template 102 is a TimeUnitProperties. TimeUnitProperties can be defined specific to any recurrence pattern. For example, different images and titles may be specified for each month of a year calendar. Virtually any attribute can be formatted with TimeUnitProperties.

Referring now to FIG. 2, various time units are illustrated. For example, FIG. 2 illustrates a day time unit 202 a week time unit 204 and a month time unit 206. As described previously the month time unit 206 and week time unit 204 may include day time units 202. Additionally, FIG. 2 illustrates that the month time unit 206 includes a week time unit 204. However, it should be noted that embodiments described herein are not constrained by traditional calendar layouts. For example, a month time unit 206 may be formatted such that the month time unit 206 does not include a week time unit. For example, the month time unit 206 may be formatted so as to include two columns or rows instead of the traditional seven columns representing the seven days of the week. While not illustrated here in FIG. 2, it should be understood that other time units may also be implemented. For example, a year time unit may be implemented. Additionally, a multi-year time unit may be implemented. Other appropriate time units may also be implemented.

Additionally, it should be noted that the calendar views 108 can be influenced by culture information. For example, the systems settings of a computer system may specify a particular culture. Illustratively, a user may indicate that the user desires to use Japanese settings. Thus, the calendar view 108 may be formatted as a traditional Japanese style calendar. To accomplish this, the calendar layout template 102 may explicitly call out the cultural style information. In other embodiments the calendar layout template 102 may reference system settings of a computer system to specify the particular culture information. Applying culture information to the calendar view 108 may affect, for example, the language used to display certain strings, the orientation of the calendar view 108 and/or information in the calendar view, the size of the calendar view 108, date format patterns, and the like.

Various views can be further implemented within the individual time unit views such as the day time unit 202 the week time unit 204, the month time unit 206, and various other time units. For example, and referring to FIG. 3, two time unit views are illustrated. The first time unit view is a list view 302. The second time unit view illustrated is a slot view 304. The list view 302 includes a listing of particular activities scheduled for a particular time unit. For example, FIG. 3 illustrates the list view 302 as a list of activities scheduled for a particular day.

A slot view 304 may include various slots within a particular time unit. For example, the day time unit view 202 of FIG. 2 may be divided into various time slots such as quarter hour time slots, half hour time slots, hour time slots and/or a mixture of varying length time slots. Scheduled activities 306 may then be graphically illustrated within the context of the time slots in the slot view 304.

While FIG. 3 illustrates a list view 302, and a slot view 304, it should be understood that other views may be implemented as well. For example, a free/busy view showing time slots as free or busy could be implemented. Various nested views could be implemented such as an appointment view within the slot view 304.

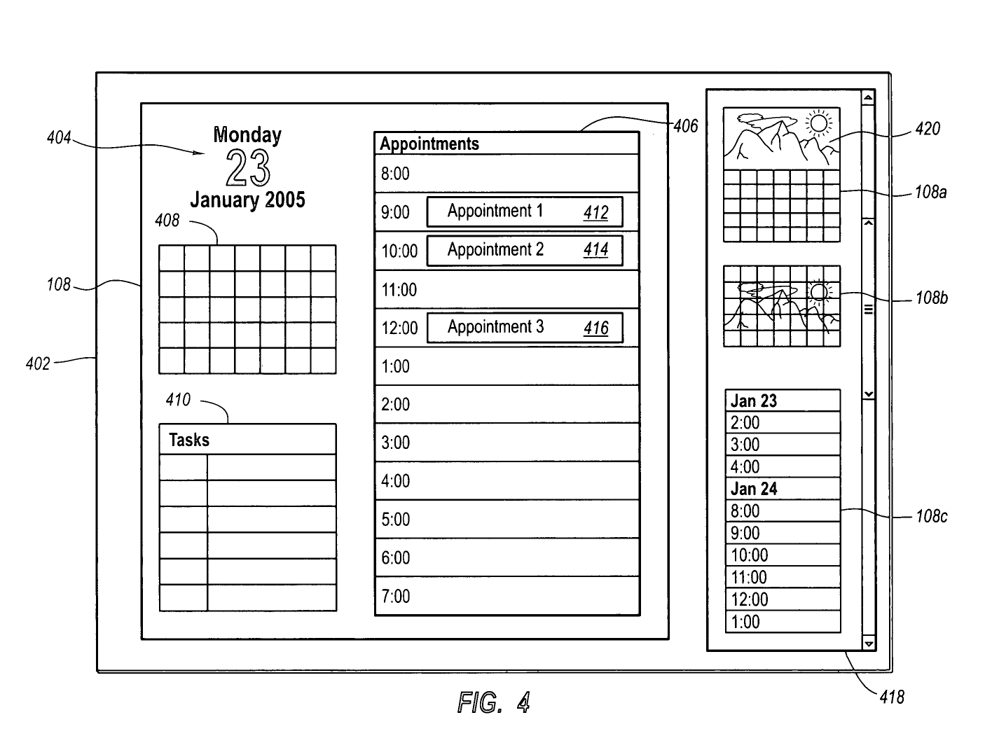

One embodiment described herein includes a graphical user interface that facilitates a user selecting a calendar layout template 102 from a selection of predefined calendar layout templates. For example, and referring to FIG. 4, a graphical user interface 402 is illustrated. The graphical user interface 402 illustrates a calendar view 108 where a selected template has been merged with appropriate schedule information and style information to form the calendar view 108. The particular calendar view 108 shown in FIG. 4 includes a date indicator 404, a day time unit 406, a month time unit 408, and a tasks block 410. The date indicator 404 lists the particular date instance for which the calendar view 108 is being created. The month time unit 408 is a standard five week/seven day month view. The day time unit 406 in this particular example is a weekday appointment view that includes hourly time slots. As such, the day time unit 406 is instantiated as a slot view. In the example shown, a first appointment 412 is illustrated in a 9:00 slot, a second appointment 414 is illustrated in the 10:00 slot, and a third appointment 416 is illustrated in the 12:00 slot.

Illustratively, the graphical user interface 402 illustrates a number of calendar views 108a 108b and 108c that may be selected. A user may select one of the calendar views 108a 108b or 108c, which are instances of calendar layout templates merged with schedule information and style information. By selecting one of the calendar views 108a 108b and 108c a user can select an appropriate calendar layout template 102 corresponding to the calendar view selected. When a user selects a calendar view from the template selection list 418, the calendar view selected will appear as the calendar view 108 in the graphical user interface 402. This calendar view 108 in the graphical user interface 402 can then be printed or otherwise used as a graphical display of the user's selection.

The calendar layout templates used to create the calendar views 108a 108b and 108c in the template selection list 418 may be created, as described above, as markup language documents. This allows third party template creators to easily create new calendar layout templates 102. These created calendar layout templates can be downloaded by a user and imported into the application implementing the graphical user interface 402 such that calendar views can be imported into the template selection list 418. As such, a virtually unlimited selection of calendars can be made available to a user. The following is an example markup document for a relatively simple month day calendar view.

```
    <MonthDayCalendar...>
      <MonthFormat>...
      </MonthFormat>
      <DayFormat>
        <Grid RowSetting=“*,Auto,Auto” ColumnSetting=“*” ...>
            <CalendarText Column=“0” Row=“0” ColumnSpan=“2”
            Text=“#[% d]” .../>
            <Grid Column=“0” Row=“1”
            HorizontalAlignment=“Center”
            RowSetting=“Auto”
            ColumnSetting=“Auto,Auto”>
              <CalendarText Column=“0” Row=“0”
              Text=“#[dddd]” .../>
              <CalendarText Column=“1” Row=“0”
              Text=“#[dddd]” .../>
            </Grid>
            <Grid Column=“0” Row=“2” RowSetting=“Auto”
ColumnSetting=“Auto,Auto”>
              <CalendarText Column=“0” Row=“0”
              Text=“#[dddd]” .../>
              <CalendarText Column=“1” Row=“0”
              Text=“#[dddd]” .../>
            </Grid>
        </Grid>
      </DayFormat>
  </MonthDayCalendar>
```

As described previously, a number of various features can be integrated into calendar templates 102. For example, as shown in FIG. 4, the calendar layout template 108 allows for a single template to include a month time unit 408 a day time unit 406 and a tasks structure 410. Various other features may also be implemented such as for example an invoice data structure, a notes structure, and the like. Additionally as shown in FIG. 4 by the calendar view 108a, calendar layout templates may include references to graphical images 420 which may be for example displayed at the top of a calendar view 108a or as a background image as shown in calendar view 108b. Additionally, those of skill and the art will understand that graphical images 420 as well as text hyperlinks and other content may be located at various other positions within a calendar view 108.

FIG. 4 further illustrates other features that may be implemented by virtue of the flexibility of the language used to create calendar layout templates. For example, calendar view 108c illustrates an interesting view where a day view includes a rolling day view. In a rolling day view, portions of two distinct dates can be displayed in a single time unit. For example, the calendar view 108c illustrates the last half of a working day labeled January 23 and the first half of the subsequent working days labeled January 24. Various other views and layouts may also be created limited only by the creativity of the calendar layout template creator. In other words, the extensibility of a language used for the calendar layout template allows for virtually unlimited configurability of calendar layout templates 102.

As described previously, the graphical user interface 402 may include user selectable elements that allow the calendar view 108 to be printed. Embodiments may therefore include functionality for facilitating enhanced printing capabilities. For example, the calendar view 108 includes information from both the calendar layout template 102 and schedule information 104. The calendar view 108 can therefore be formatted such that when the calendar view 108 is selected to be of a particular size, the text displayed in the calendar view can be sized appropriately so as to minimize or eliminate the loss of information. Illustratively, scheduling programs in the present art may include printing functionality. However those scheduling programs often use the same code that generates a screen rendering to generate printed output. Because schedules on a computer screen allow for scrolling, there is often no need to resize information such that all information can be seen on a single screen. However, when such screen rendering information is used for printing to a hard copy, information is commonly lost when hidden within a scroll window. Embodiments herein, however, allow for schedule information 104 to be resized within the calendar view 108 automatically by the application used to create the calendar view 108 so as to preserve information when the calendar view 108 is printed.

The graphical user interface at 402 may further include user selectable elements that allow a calendar view 108 to be defined within a particular size or orientation. For example, a user may select a page view size and an orientation such as a landscape or portrait orientation. The markup language allows the calendar view 108 to be dynamically adjusted when page size and orientation information is merged with the calendar layout template 102. When the page size and orientation information is merged with the calendar layout template 102 the calendar view 108 can be dynamically adjusted to minimize or eliminate the loss of information by adjusting for example font sizes, slot dimensions, and other features within the calendar view 108.

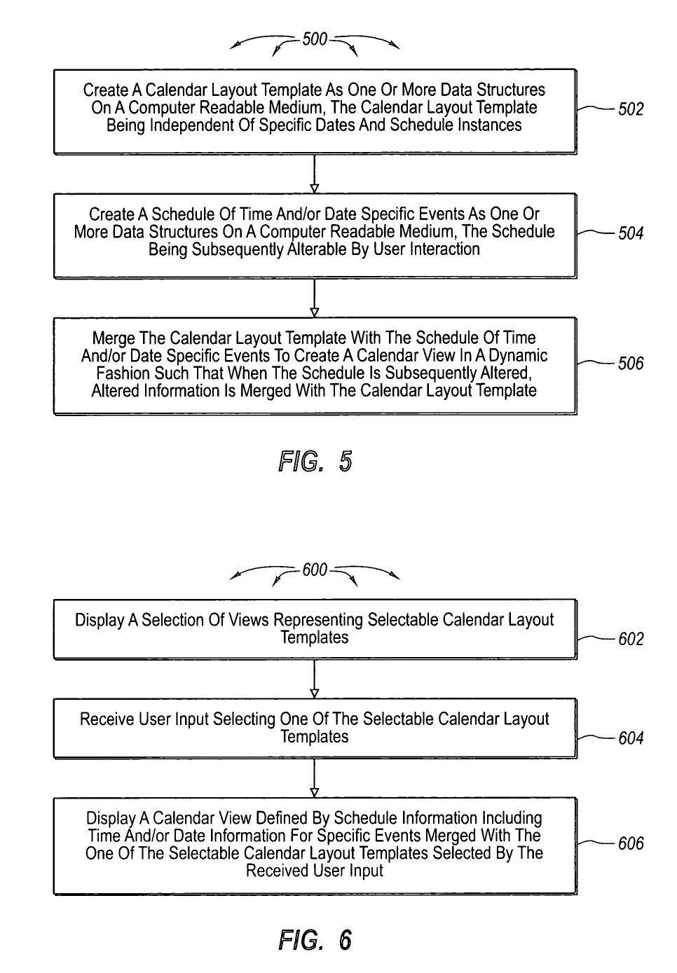

Referring now to FIG. 5, a method is illustrated for displaying a calendar. The method may be practiced for example in a computing environment. The method includes creating a calendar layout template as one or more data structures on a computer readable medium (act 502). The calendar layout template is independent of specific dates and schedule instances.

The calendar layout template may include one or more time units. For example, the calendar layout template may define one or more of a multi-year time unit, a year time unit, a month time unit, a week time unit, and a day time unit. For example, as illustrated in FIG. 2, the calendar layout template may define time units such as the day time unit 202, the week time unit 204, the month time unit 206, and although not shown, year time units or multi year time units. In one embodiment, one primary time unit is defined for the template. The primary time unit may include calendar controls that allows for other time units to be nested within the one primary time unit. For example, if a template defines a year time unit, the year time unit may include calendar controls that allow month, week and day time units to be defined within the year time unit. As such a time unit may be defined within another time unit. For example, as illustrated in FIG. 2, a day time unit 202 can be defined within a week time unit 204 or month time unit 206. Further, a week time unit 204 may be defined within a month time unit 206, and so forth. However, the time units are not necessarily constrained by traditional layouts. For example month and week views may be displayed with arbitrary columns and rows instead of the traditional seven columns for months and weeks representing days of the week.

Embodiments described herein further allow for a time unit to be displayed disjoint from another time unit. For example, FIG. 4 illustrates a calendar view 108 that includes a month time unit 408 that is disjoint from a day time unit 406. While the calendar view 108 may display similar schedule information in the day time unit 406 and the month time unit 408, the graphical structure of the two may nonetheless be disjoint.

Creating a calendar layout template (act 502) may include defining and/or specifying fonts, borders, shading, and the like. For example, a font may be specified from among a number of available fonts installed at a system. For example, True Type or Postscript type fonts may be installed at a system. One of the fonts installed can be specified for use in all or part of the calendar layout template. Shading, color schemes, borders, and the like may be defined within the calendar layout template. For example, these various features may be defined using a markup language such as the Windows Foundation Classes brush markup available from Microsoft Corporation of Redmond Wash.

In one embodiment, a separate style information data structure may be used to define various features of a calendar view. As illustrated in FIG. 1, style information 106 may be applied to the calendar layout template 102 to create the calendar view 108. The style information 106 may include for example, colors, fonts, shading, calendar style, and the like.

Creating a calendar layout template may include defining views for one or more time units. For example, views may be list views or a slot views. As illustrated in FIG. 3, a list view 302 lists scheduled events or activities in a list. The list may be a chronological listing of activities or any other suitable listing. The list may also include a notation specifying any appropriate information such as time of the activity, place of the activity and the like. The slot view 304 shows activities as constrained by predefined slots within the slot view 304. As described previously, slots may be defined as discrete time units in which a schedule activity fits. Notably, because of the extensible nature of the calendar layout template, the discrete time units can vary widely. For example, the discrete time units defining the slots could be minutes, hours, days, or portions thereof.

As described previously, creating a calendar layout template may include creating an XML file. XML files are useful as they provide a readily accessible format for template designers. Additionally, XML files may be useful in Web Services applications. Web Services is a standardized way of integrating applications. Standardized XML documents can be used with SOAP (Simple Object Access Protocol) messages and WSDL (Web Services Description Language) descriptions to integrate applications without an extensive knowledge of the applications being integrated.

Notably, as used herein, creating a calendar layout template may include importing a template file. For example, template designers may design template files. Users can then download those template files and create a copy of the template file as a calendar layout template locally by importing the template file. This results in a new template being created locally as an imported copy of a template file available in a remote location.

Referring once again to FIG. 5, the method 500 further includes creating a schedule of time and/or date specific events as one or more data structures on a computer readable medium (act 504). The schedule may be alterable by user interaction. For example, a user may create schedule events by interacting with a scheduling program such as Microsoft Outlook. The schedule then becomes available for use in creating a calendar view. The user can alter the events within the schedule.

Referring once again to FIG. 5, the method 500 further includes merging the calendar layout template with the schedule of time and/or date specific events to create a calendar view (act 506) The calendar layout template and the schedule of time and/or date specific events may be merged in a dynamic fashion such that when the schedule is altered, altered information is merged with the calendar layout template. For example, the calendar view 108 shown in FIG. 4 can update any of the appointments 412, 414, and 416 by updating schedule information in a scheduling program. The dynamic linking between a calendar layout template 102 (FIG. 1) and schedule information 104 allows the calendar view 108 to be automatically updated with the new schedule information.

The method 500 may further include dynamically altering content size to prevent loss of information when a calendar view is displayed or printed. For example, and referring again to FIG. 4, the calendar view 108 includes various content information such as textual information in headers as well as textual information describing appointments, tasks and the like. One embodiment may include altering the size of characters used so as to prevent information from being lost. For example, characters will be sized such that they can continue to be displayed in a single screen view or displayed when a calendar view 108 is subsequently printed. While in this example textual font sizes have been described, it should be noted that other features may also be appropriately sized to prevent the loss of information. For example the image 420 shown in the calendar view 108a may be resized so as to eliminate or minimize the amount of loss when a particular size is selected for display or printing of the calendar view 108a.

The method 500 may further include merging style information with the calendar layout template. For example, and referring again to FIG. 1, style information 106 may be merged with the calendar layout template 102 to produce the calendar view 108. The style information may include for example various features such as color schemes, fonts, graphical designs, calendar style, and so forth. In one embodiment, style information may be defined through the use of a graphical by user interface such as the graphical user interface 402 illustrated and FIG. 4. The graphical user interface may provide selectable elements that allow a user to customize the calendar view 108.

The method 500 may also include merging external information with the calendar layout template. As illustrated and FIG. 1, the external information 110 may be merged with a calendar layout template 102. As described herein, the external information may include for example graphical images, text, maps, news content, and so forth.

As described previously the schedule of time and/or date specific events may be from multiple sources. In one embodiment, when this is the case, the method 500 further includes displaying the calendar view with the schedule of time and/or date specific events is from multiple sources displayed in a single time unit. For example, schedule information for two individuals may be merged together and displayed in a single time unit such as a single day view.

In an alternative embodiment, when the schedule of time and/or date specific events is from multiple sources, the method 500 may further include displaying the calendar view with the schedule of time and/or date specific events from multiple sources displayed with schedule of time and/or date specific events in different time units. For example, in one embodiment a side by side or top and bottom display may display one source of schedule information in the first time unit and another source of schedule information in a second time unit.

Referring now to FIG. 6, a method of presenting calendar views including schedule information merged with a calendar layout template is illustrated. The method may be practiced for example in a computer system having a graphical user interface including a display and a user interface selection device. For example, the graphical user interface may be displayed on a display device such as a CRT, LCD or other appropriate display. User interface devices may include for example keyboards, mice, trackballs, touch screens, pen tablets, or any other appropriate and suitable device.

The method includes displaying a selection of views representing selectable calendar layout templates (act 602). For example, and referring to FIG. 4, a template selection list 418 is illustrated. While in the example shown in FIG. 4, the template selection list 418 illustrates calendar views 108a, 108b, 108c, embodiments described in herein contemplate that more generic representations of calendar layout templates may also be illustrated. For example, use representing calendar layout templates 102 may be displayed without specific schedule information 104 pre-merged as shown in the calendar views selection list 118 of FIG. 4.

Referring once again to FIG. 6, the method 600 further includes receiving user input selecting one of the selectable calendar layout templates (act 604). For example, a user may use one of the user interface selection devices to select one of the calendar views 108a, 108b, or 108c from the template selection list 418.

Referring once again to FIG. 6, the method 600 further includes displaying a calendar view defined by schedule information including time and/or date information for specific events merged with the one of the selectable calendar layout templates selected by the received user input (606).

Displaying a selection of views representing selectable calendar layout templates may include displaying calendar views. For example, FIG. 4 illustrates calendar views in the template selection list 418 which may be used to select a calendar layout template. As noted above, more generic views may also be implement to facilitate selection of a calendar layout template.

The method 600 may further include receiving user input defining style information. For example, a user may be able to select elements within the graphical user interface 402 to select style information 106 that may be used to define the calendar view 108. Such style information may include for example, fonts, color schemes, themes, calendar style, and the like.

The method 600 may further include receiving user input defining a date or range of dates. In this example, displaying a calendar view defined by schedule information (act 606) includes displaying time/or date information for specific events falling on the date or range of dates.

Embodiments may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a computing environment, a method of displaying a calendar, the method comprising:
creating a calendar layout template as one or more data structures on a computer readable medium, the calendar layout template being independent of specific dates and schedule instances;
creating a schedule of time and/or date specific events as one or more data structures on a computer readable medium, the schedule being alterable by user interaction; and
merging the calendar layout template with the schedule of time and/or date specific events to create a calendar view in a dynamic fashion such that when the schedule is altered, altered information is merged with the calendar layout template.

2. The method of claim 1, wherein the calendar layout template defines one or more time units, wherein each time unit is at least one of a multi-year time unit, a year time unit, a month time unit, a week time unit, and a day time unit.

3. The method of claim 2, wherein at least one time unit is defined within another time unit.

4. The method of claim 2, wherein at least one time unit is displayed disjoint from another time unit.

5. The method of claim 1, wherein creating a calendar layout template comprises at least one of a specifying a font, defining a border, and defining shading.

6. The method of claim 1, wherein creating a calendar layout template comprises defining views for one or more time units as at least one of a list view, a slot view, a free/busy view, a grid view, or an appointment view.

7. The method of claim 1, wherein creating a calendar layout template comprises creating an XML file.

8. The method of claim 1, wherein creating a calendar layout template comprises importing a template file from a remote location and creating a stored copy of the template file.

9. The method of claim 1, further comprising dynamically altering content size to prevent loss of information when a calendar view is printed or displayed.

10. The method of claim 1, further comprising merging style information with the calendar layout template.

11. The method of claim 1, further comprising merging external information with the calendar layout template.

12. The method of claim 1 wherein the schedule of time and/or date specific events includes events from multiple sources, the method further comprising displaying the calendar view with the schedule of time and/or date specific events from multiple sources displayed in a single time unit.

13. The method of claim 1 wherein the schedule of time and/or date specific events includes events from multiple sources, the method further comprising displaying the calendar view with the schedule of time and/or date specific events from multiple sources displayed with schedule of time and/or date specific events in different time units.

14. One or more computer readable media comprising:
a first data structure, the first data structure including information defining a calendar layout, the calendar layout being independent of specific dates and schedule instances;
a second data structure, the second data structure including information defining a schedule of time and/or date specific events, the schedule being alterable by user interaction; and
computer executable instructions configured to merge the information defining the first data structure with the information defining the schedule of time and/or date specific events in a dynamic fashion such that when the schedule is altered, altered information is merged with the one or more calendar layouts.

15. The one or more computer readable media of claim 14, further comprising a third data structure defining style information, the style information including at least one of a color scheme definition, an orientation specification, a font specification, border definitions, shading definitions, and culture specification.

16. The one or more computer readable media of claim 14, wherein the first data structure defines one or more time units, the one or more time units being at least one of a day time unit, a week time unit, a month time unit, a year time unit, and a multi year time unit.

17. The one or more computer readable media of claim 15, wherein at least one of the one or more time units defines another time unit within the at least one time unit.

18. The one or more computer readable media of claim 14, wherein the first data structure defines conditional formatting attributes specifying formatting for other attributes defined in the first data structure.

19. The one or more computer readable media of claim 14, wherein the first data structure defines time unit properties defining properties for a recurrence pattern.

20. In a computer system having a graphical user interface including a display and a user interface selection device, a method of presenting calendar views including schedule information merged with a calendar layout template, the method comprising:
displaying a selection of views representing selectable calendar layout templates;
receiving user input selecting one of the selectable calendar layout templates; and
displaying a calendar view defined by schedule information including time and/or date information for specific events merged with the one of the selectable calendar layout templates selected by the received user input.

21. The method of claim 20, wherein displaying a selection of views representing selectable calendar layout templates comprises displaying calendar views.

22. The method of claim 20, further comprising receiving user input defining a date or range of dates and wherein displaying a calendar view defined by schedule information comprises displaying time/or date information for specific events falling on the date or range of dates.

23. The method of claim 20, further comprising: receiving user input defining at least one of a page view size or an orientation; and
dynamically adjusting the calendar view to minimize or eliminate the loss of information.
